(19) United States
(12) Patent Application Publication
(10) Pub. No.: US 2003/0229618 A1
(43) Pub. Date: Dec. 11, 2003

(54) System and method for project tracking and reporting

(76) Inventor: Deborah Judy, Bowie, MD (US)

Correspondence Address: Finnegan, Henderson, Farabow,, Garrett & Dunner, L.L.P., 1300 I Street, N.W., Washington, DC, 20005-3315, US

(21) Appl. No.: 10/436,675

(22) Filed: May 13, 2003

Related U.S. Application Data
(60) Provisional application No. 60/380,323, filed on May 14, 2002.

(51) Int. Cl. G06F 7/00

(52) U.S. Cl. 707/1

(57) ABSTRACT

A method of tracking a project file. The method comprises uploading a project file to a host system; storing the project file in the host system; mapping at least one resource records from a resources database to a task within the project file, resulting in a mapped project file; and storing the mapped project file on the host system.

### RELATED APPLICATIONS

The application claims the benefit of priority from provisional U.S. Patent Application Serial No. 60/380,323, entitled “Project Tracking and Reporting System (PTRS),” filed May 13, 2002, which is expressly incorporated herein by reference.

### TECHNICAL FIELD

The invention relates to the field of project management, and more specifically, a system for and method of tracking and reporting projects.

### BACKGROUND

Project management tools have existed for years. Everyone involved in project engineering is familiar with the Gant chart, which organizes a series of tasks comprising a project according to start dates, end dates, and milestones. In addition, resources must be assigned to complete the tasks within the project plan. Project planners need a convenient resource pool from which to draw and assign resources, and the resource pool needs to track the allocation of its resources.

However, planning a project is only a first step in project management. Projects have to go through approval processes, and, once a project begins, the actual implementation of the tasks associated with the project needs to be tracked. Projects need to be tracked to provide accountability for project implementation. Project accountability and tracking is not only important in the private sector, but also in the government where laws, such as the Clinger-Cohen Act, were passed in response to perceived excessive spending by federal agencies.

In order to address accountability and comply with the Clinger-Cohen Act, the General Accounting Office recommends an Information Technology Investment Management Methodology involving three phases: Selection, Control, and Evaluation. The Control phase is a particularly critical phase, requiring a focus on project monitoring, project analysis, and adjusting activities. Systems are needed to implement at least one aspects of the Control phase.

The present invention is directed to overcoming at least one of the above problems and achieving at least one of the above stated goals.

### SUMMARY OF THE INVENTION

In accordance with an aspect of the present invention, a method is provided of tracking a project file. The method comprises uploading a project file to a host system; storing the project file in the host system; mapping at least one resource records from a resources database to a task within the project file, resulting in a mapped project file; and storing the mapped project file on the host system.

In accordance with another aspect of the present invention, a method is provided of reporting tracking information on project files. The method comprises baselining at least one tasks of a project file, wherein the project file comprises at least one tasks with associated projected data; pushing the at least one baselined tasks to a cost tracking system; receiving actual data associated with the at least one baselined tasks from the cost tracking system; comparing the actual data from the costs tracking system with the projected data; and providing a report of the actual data and the projected data.

In accordance with another aspect of the present invention, a system is provided for tracking a project file. The system comprises: a memory; a database; and a processor coupled to the memory and the database. The processor is configured to: receive a project file; store the project file in the database; map at least one resource record from the database to a task within the project file to produce a mapped project file; and store the mapped project file in the database.

In accordance with another aspect of the present invention, a system is provided for reporting tracking information on project files. The system comprises: a memory; a database; a processor coupled to the memory and the database. The processor is configured to: baseline at least one task of a project file, wherein the project file comprises at least one task with associated projected data; push the at least one baselined task to a cost tracking system; receive actual data associated with the at least one baselined tasks from the cost tracking system; compare the actual data from the costs tracking system with the projected data; and generate a report of the actual data and the projected data.

In accordance with another aspect of the present invention, a computer-readable medium is provided on which is stored a set of instructions for tracking a project file. The instructions, when executed, perform stages comprising: uploading a project file to a host system; storing the project file in the host system; mapping at least one resource record from a resources database to a task within the project file to produce a mapped project file; and storing the mapped project file on the host system.

In accordance with another aspect of the present invention, a computer-readable medium is provided on which is stored a set of instructions for reporting tracking information on project files. The instructions, when executed, perform stages comprising:

baselining at least one task of a project file, wherein the project file comprises at least one task with associated projected data; pushing the at least one baselined tasks to a cost tracking system; receiving actual data associated with the at least one baselined tasks from the cost tracking system; comparing the actual data from the costs tracking system with the projected data; and generating a report of the actual data and the projected data.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the invention and, together with the description, serve to explain the principles of the invention.

FIG. 1 is an illustration of a system consistent with the present invention in its operating environment.

FIG. 2 is a system diagram of components utilized with a project monitoring system consistent with the present invention.

FIG. 3 is a block diagram of a PTRS Host 110 consistent with the present invention.

FIG. 4 is a block diagram of a workstation 120 consistent with the present invention.

FIG. 5 is a process flow diagram of the new project upload and resource assignment process consistent with the present invention.

FIG. 6 is a flowchart of the project tracking and analysis method consistent with the present invention.

FIG. 7 is a more detailed flowchart of the mapping method consistent with the present invention.

FIG. 8 is a more detailed flowchart of the project push method of consistent with the present invention.

FIG. 9 is a more detailed flowchart of the cost comparison and reporting method consistent with the present invention.

FIGS. 10a-10e are screen images of the reporting screens consistent with the present invention.

### DETAILED DESCRIPTION

Reference will now be made in detail to the present exemplary embodiments consistent with the invention, examples of which are illustrated in the accompanying drawings. Wherever possible, the same reference numbers will be used throughout the drawings to refer to the same or like parts.

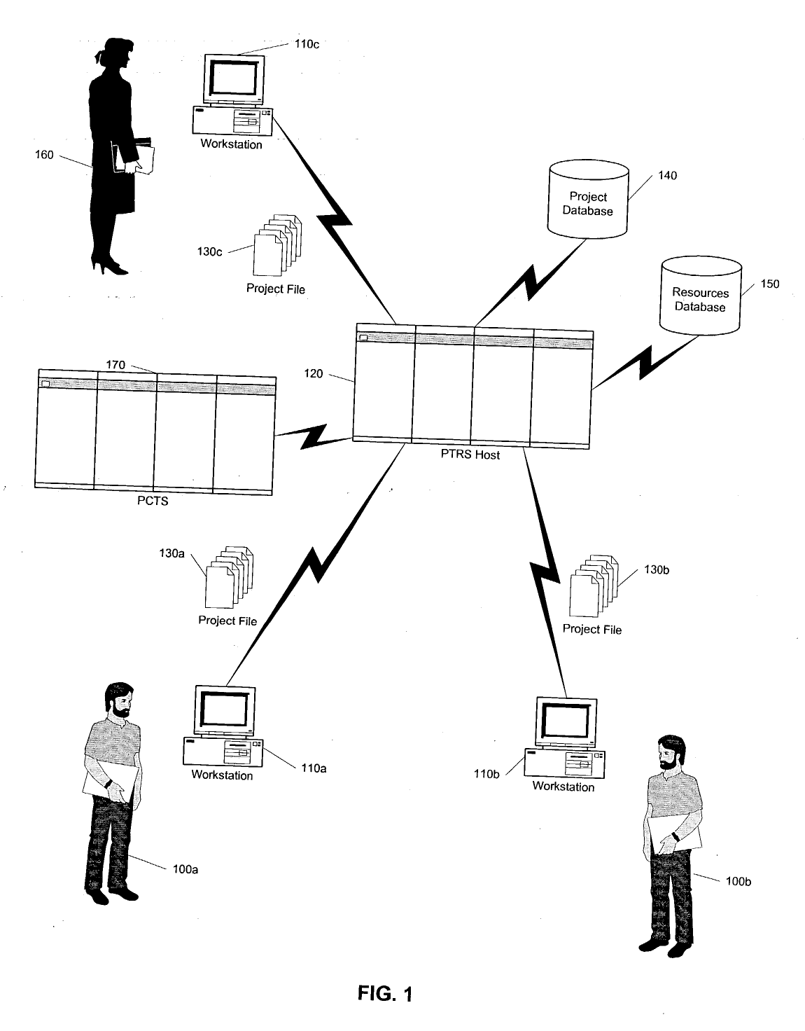

FIG. 1 is an illustration of a system consistent with the present invention in its operating environment. A project user 100a may create project files 130, such as project file 130a, on a workstation 110, such as workstation 1 10a, and upload project file 130a to a Project Tracking and Reporting System Host (“PTRS Host”) 120. Project file 130a may have been created with a project management tool, for example, Microsoft Project. If utilizing Microsoft Project, project file 130a may be in .mpp format. Other users, such as user 100b and project manager 160, may create other projects 130, such as projects 130b and 130c. Those skilled in the art will appreciate that other formats and other project management tools may be utilized in applications consistent with the present invention. PTRS Host 120 may provide a web based or custom interface to provide access to and modification of project files within project database 140.

Once project file 130a is uploaded to PTRS Host 120, PTRS Host 120 may store project file 130a in a project database 140. Project database 140 may be at least one database servers or cluster of servers located locally, remotely, or within PTRS Host 120. By drawing upon project database 140, PTRS Host 120 may provide project file 130a to other project users, for example project user 100b utilizing workstation 110b, for viewing, printing, or modification.

Project users may assign resources to at least one tasks within at least one project files 130. Assignment is the process whereby a project user designates a resource to be used in completion of a task. A resource may be, for example, a specific individual or a generic resources, such as: an occupational position, (e.g., Level II Program Analyst), a Contractor designation; or an Organization designation, )e.g,. Planning and Support Department). Mapping is the process whereby the PTRS Host 120 links resource records from resource database 150 to be used in the completion of a task. For example, a resource, “Bob Smith” may be assigned to a task, for example, “User Interface Design,” by project user 100b. Continuing the example, PTRS Host 120 may map the assigned resource record associated with “Bob Smith,” for example, “resource record 1493—Bob Smith,” to the task of “User Interface Design,” whereby resource record 1493 in resources database 150 may be linked to the task “User Interface Design.”

By drawing upon a resources file of resource records within a resources database 150, PTRS Host 120 may map resources from resources database 150 to tasks within project file 130. Following resource mapping, project users may download a project file 130 into their workstation 110 for viewing the project with the associated mapped resources. Similarly, a project user 100a may assign resources locally on his workstation 110a, upload project file 130a with assigned resources to PTRS Host 120, and proceed to map the assigned resources to resource records in the resource file of resources database 150.

PTRS Host 120 may access a Project Cost Tracking System (“PCTS”) 170 for gaining access to actual budgetary and other task figures as a project file is implemented. In this way, PTRS Host 120 may provide a number of analysis and reporting functions useful for project management. For example, PTRS Host 120 may provide overviews of actual versus budgeted costs, highlighting cost overruns, and permitting “drilling down” into the

Project manager 160 may utilize workstation 110 to also view and edit project files 130. Project manager 160 may also review project files 130 and grant approval.

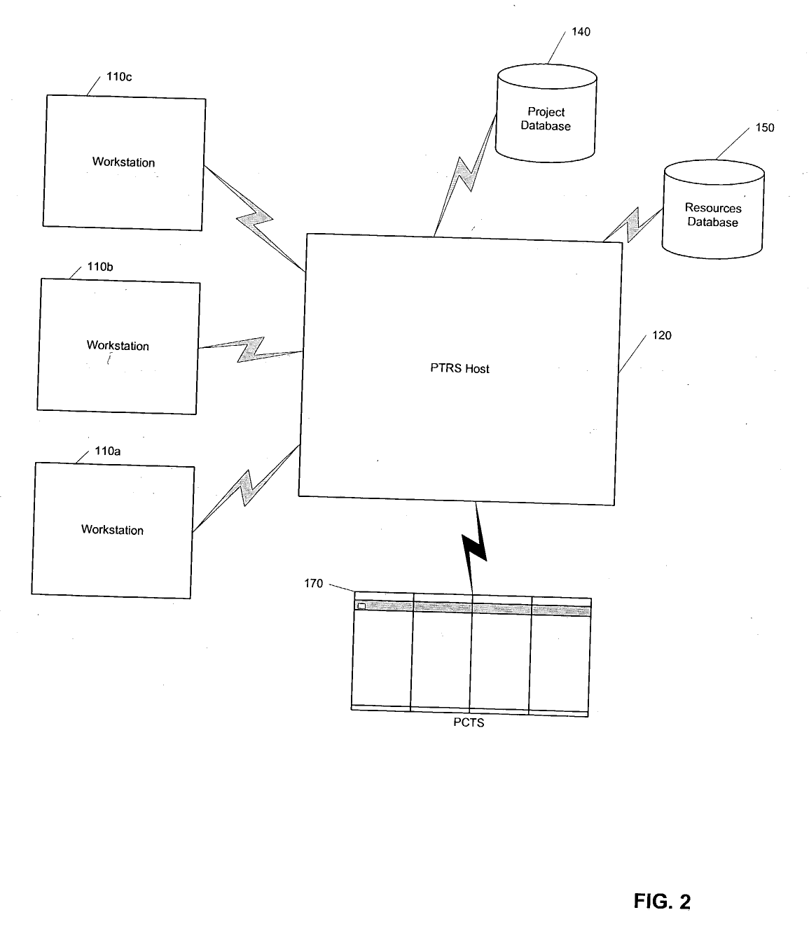

FIG. 2 is a system diagram of components utilized with a project monitoring system consistent with the present invention. PTRS Host 120 may comprise project tracking, analysis, and reporting functions that interface with external systems, such as workstations 10a-c, PCTS 170, project database 140, and resources database 150. The interface with the PTRS Host may be via a LAN, WAN, direct connection, or a network such as the Internet.

Project database 140 serves as a central storage location for project files which may be accessed by PTRS Host 120.

Resources database 150 stores a database or list of all available resources that may be assigned to tasks within a project file. Resources database 150 may maintain at least one resource records associated with each resource noting the availability of the resource, to which tasks of project files the resource is mapped, skills associated with the resource, and pertinent employment information of the resources. A resource skills questionnaire may be periodically generated by PTRS Host 120 and sent to resources to update the resource records.

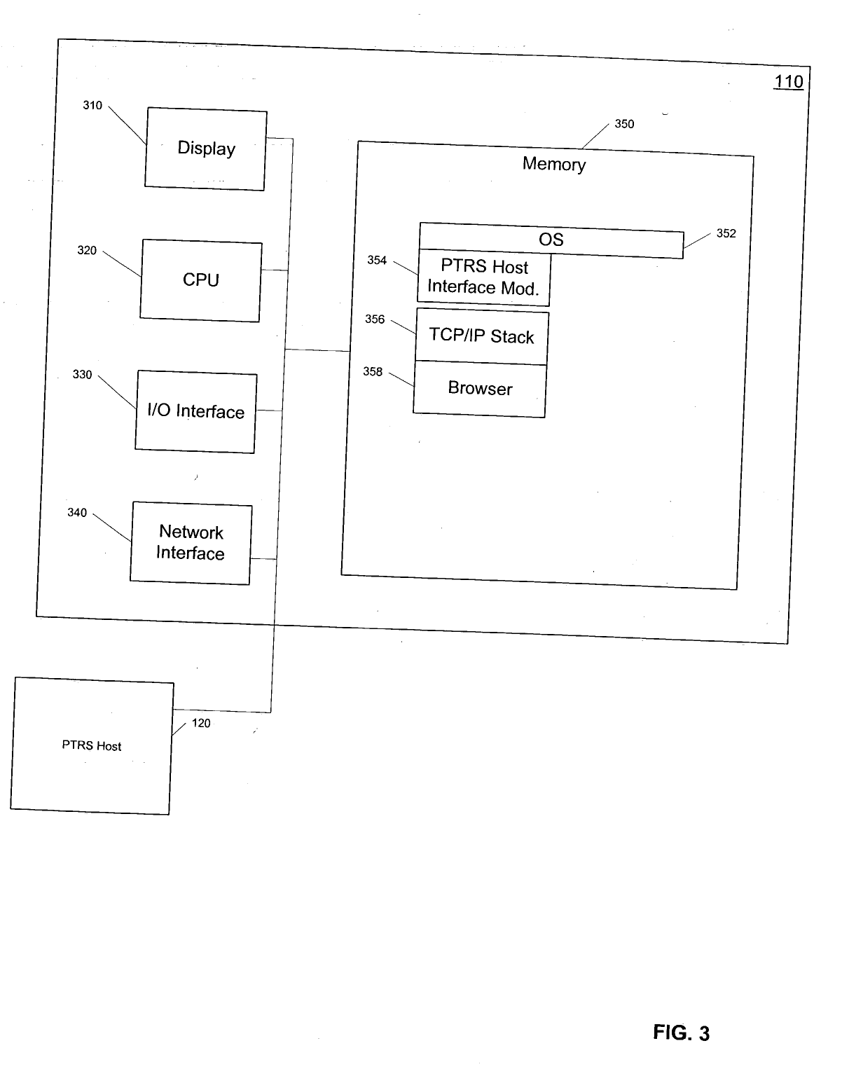

FIG. 3 is a block diagram of a workstation 110 consistent with the present invention. As illustrated in FIG. 3, a system environment of workstation 110 may include a display 310, a central processing unit 320, an input/output interface 330, a network interface 340, and memory 350 coupled together by a bus. Workstation 110 may be adapted to include the functionality and computing capabilities to create, manage, edit, and save project files using a local project management program, such as Microsoft Project; and upload and download project files to PTRS Host 120. The input, output, and monitoring of the system may be provided on display 310 for viewing.

As shown in FIG. 3, workstation 110 may comprise a PC or mainframe computer for performing various functions and operations consistent with the invention. Workstation 110 may be implemented, for example, by a general purpose computer selectively activated or reconfigured by a computer program stored in the computer, or may be a specially constructed computing platform for carrying-out the features and operations of the present invention. Workstation 110 may also be implemented or provided with a wide variety of components or subsystems including, for example, at least one of the following: at least one central processing units 320, a co-processor, memory 350, registers, and other data processing devices and subsystems.

Workstation 110 may also communicate or transfer project files via I/O interface 330 and/or network interface 340 through the use of direct connections or communication links to other elements of the present invention. For example, a firewall in network interface 340, prevents access to the platform by unpermitted outside sources.

Alternatively, communication within workstation 110 can be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, workstation 110 may be located in the same location or at a geographically distant location from systems 110, 130, 150, and 170.

I/O interface 330 of the system environment shown in FIG. 3 may be implemented with a wide variety of devices to receive and/or provide the data to and from workstation 110. I/O interface 330 may include an input device, a storage device, and/or a network. The input device may include a keyboard, a mouse, a disk drive, video camera, magnetic card reader, or any other suitable input device for providing data to workstation 110.

Network interface 340 may be connected to a network, such as a Wide Area Network, a Local Area Network, or the Internet for providing read/write access to records.

Memory 350 may be implemented with various forms of memory or storage devices, such as read-only memory (ROM) devices and random access memory (RAM) devices. Memory 350 may also include a memory tape or disk drive for reading and providing records on a storage tape or disk as input to workstation 110. Memory 350 may comprise computer instructions forming: an Operating System 352; a PTRS Host Interface Module 354 for accessing PTRS Host 120; a TCP/IP Stack 356 for providing Internet functionality; and a Browser 358 such as Microsoft Internet Explorer.

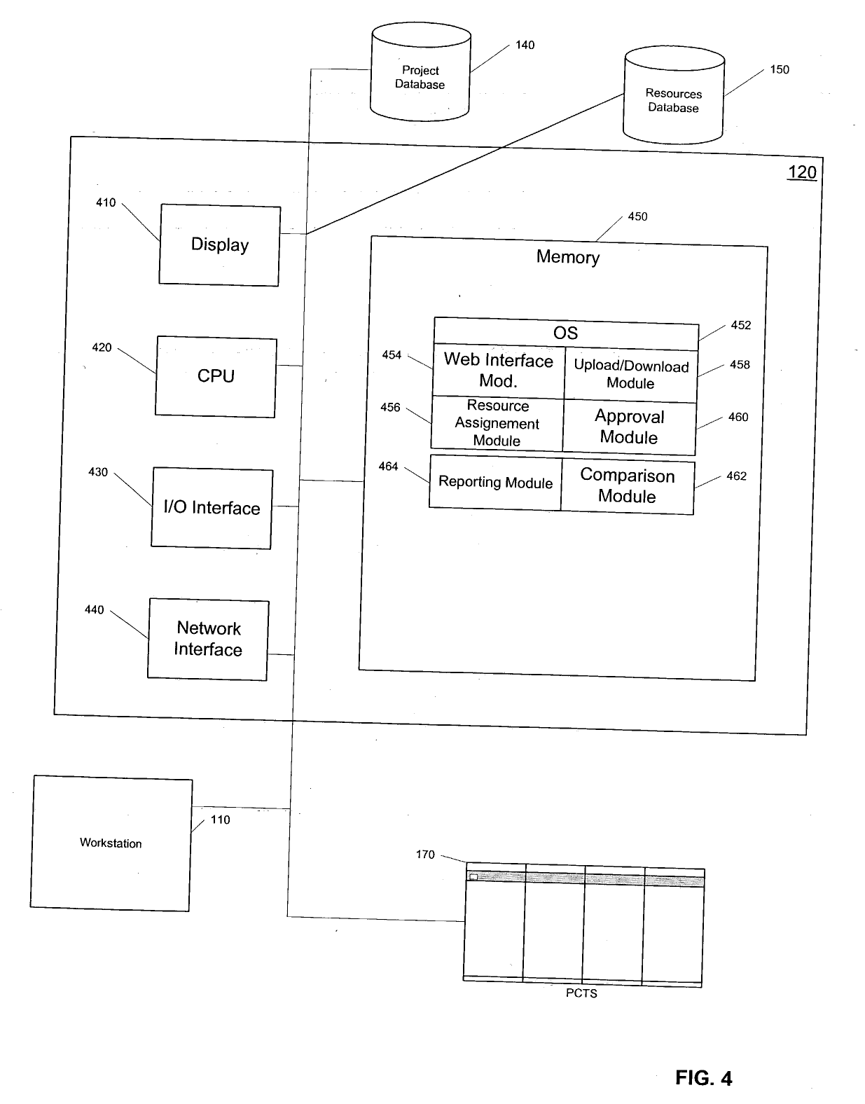

FIG. 4 is a block diagram of PTRS Host 120 consistent with the present invention. As illustrated in FIG. 4, a system environment of PTRS Host 120 may include a display 410, a central processing unit 420, an input/output interface 430, a network interface 440, and a memory 450 coupled together by a bus. PTRS Host 120 is adapted to include the functionality and computing capabilities to implement the described planning, analysis, and reporting functions of PTRS Host 120 and to access, read, and write to project database 140 and resources database 150. In addition, PTRS Host 120 may interface to workstations 110 and PCTS 170. The input, output, and monitoring of the system may be provided on display 410 for viewing.

As shown in FIG. 4, PTRS Host 120 may comprise a PC or mainframe computer for performing various functions and operations consistent with the invention. PTRS Host 120 may be implemented, for example, by a general purpose computer selectively activated or reconfigured by a computer program stored in the computer, or may be a specially constructed computing platform for carrying-out the features and operations of the present invention. PTRS Host 120 may also be implemented or provided with a wide variety of components or subsystems including, for example, at least one of the following: at least one central processing units 420, a co-processor, memory 450, registers, and other data processing devices and subsystems.

PTRS Host 120 may also communicate or transfer project files and actual data via I/O interface 430 and/or network interface 440 through the use of direct connections or communication links to other elements of the present invention. For example, a firewall in network interface 440, prevents access to the platform by unpermitted outside sources.

Alternatively, communication within PTRS Host 120 can be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, PTRS Host 120 may be located in the same location or at a geographically distant location from systems 110, 140, 150, and 170.

I/O interface 430 of the system environment shown in FIG. 4 may be implemented with a wide variety of devices to receive and/or provide the data to and from PTRS Host 120. I/O interface 430 may include an input device, a storage device, and/or a network. The input device may include a keyboard, a mouse, a disk drive, video camera, magnetic card reader, or any other suitable input device for providing data to PTRS Host 120.

Network interface 440 may be connected to a network, such as a Wide Area Network, a Local Area Network, or the Internet for providing read/write access to records.

Memory device 450 may be implemented with various forms of memory or storage devices, such as read-only memory (ROM) devices and random access memory (RAM) devices. Memory device 450 may also include a memory tape or disk drive for reading and providing records on a storage tape or disk as input to PTRS Host 120. Memory device 450 may comprise computer instructions forming: an Operating System 452; a Web Interface Module 454 for providing web based access to workstations; an Upload/Download Module 458 for providing the ability to upload and download project files to project database 140; a Resource Mapping Module 456 for providing access to resource records in resources database 150, as well as the functionality to read, write, and modify resource records and to provide a resource survey to update resource records; an Approval Module 460 for providing the functionality to allow project users to designate tasks and projects for approval requests, and allow program manager 160 to approve projects; a Reporting Module 464 for providing reporting and “drill down” functions; and a Comparison Module 462 for reading actual data from a cost system such as PCTS 170.

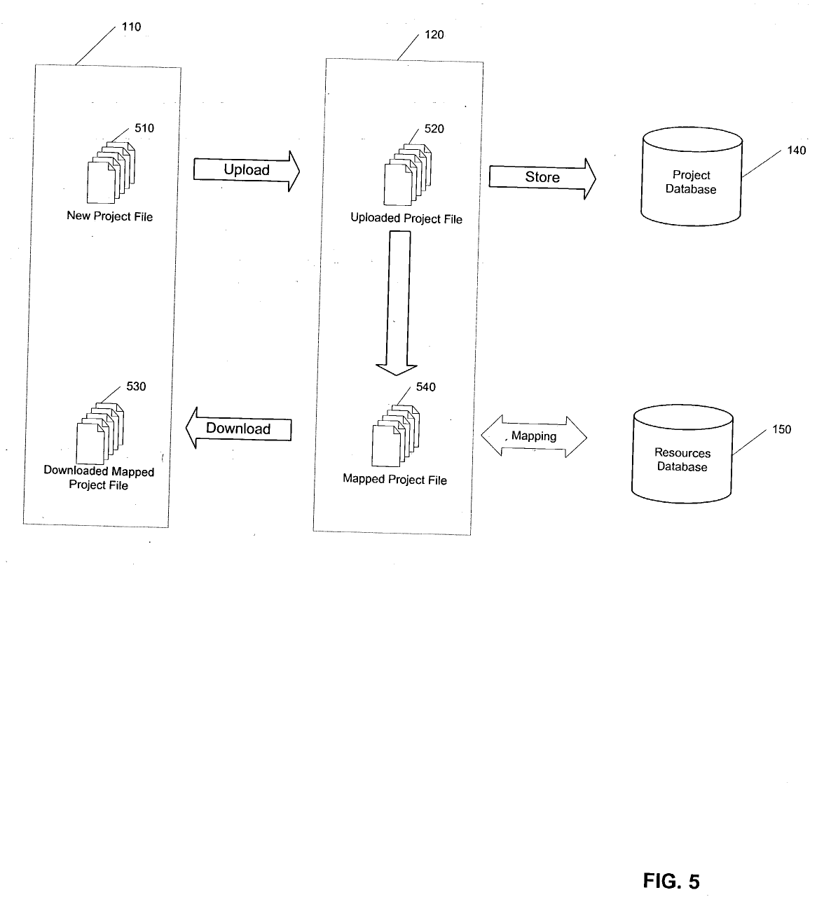

FIG. 5 is a process flow diagram of a new project upload and resource assignment process consistent with the present invention. When a project user 110 creates a new project file 510 or modifies an existing project file, the project user may upload the project file to project database 140 for storage and mapping of resources. The project file may contain at least one resources assigned to at least one tasks. A new project file 510, or a modified project file, may be stored on a workstation 110. New project file 510 may have been created with a project management program, such as Microsoft Project, and saved to local storage by workstation 110. New project file 510 may be stored in the .mpp format, or any other format used with project management programs.

Workstation 110 accesses PTRS Host 120 and request an upload of new project file 510 to PTRS Host 120. PTRS Host 120 may receive new project file 510 and store it as an uploaded project file 510 to project database 140. Uploaded project file 520 may be stored in its original format (*.mpp), a modified format, or a proprietary format.

Following storage of uploaded project file 520, a project user may choose to have PTRS Host 120 map resources to at least one tasks within uploaded project file 520. Utilizing the resource records within resources database 150, PTRS Host 120 may map at least one resources, perhaps previously assigned, to at least one tasks within uploaded project file 520 (a process known as “mapping”). The PTRS Host 120 may automatically map resource records to tasks based on assigned resources, or project user 110a may be presented with a list of resources from which to choose for each task or may select from among generic resources, such as: an occupational position, (e.g., Level II Program Analyst), a Contractor designation; or an Organization designation, (e.g., Planning and Support Department).

As resource records are mapped from resources database 150 to uploaded project file 520, mapped uploaded project file 520 is saved as a mapped project file 540 within project database 140. Resources database 150 may also have resource records updated to reflect the mapped status of mapped resource records. For example, “resource record 1298—Bob Davies” may reflect that employee Bob Davies has been mapped, or assigned, to project 013 from May 1, 2003 to June 27, 2003.

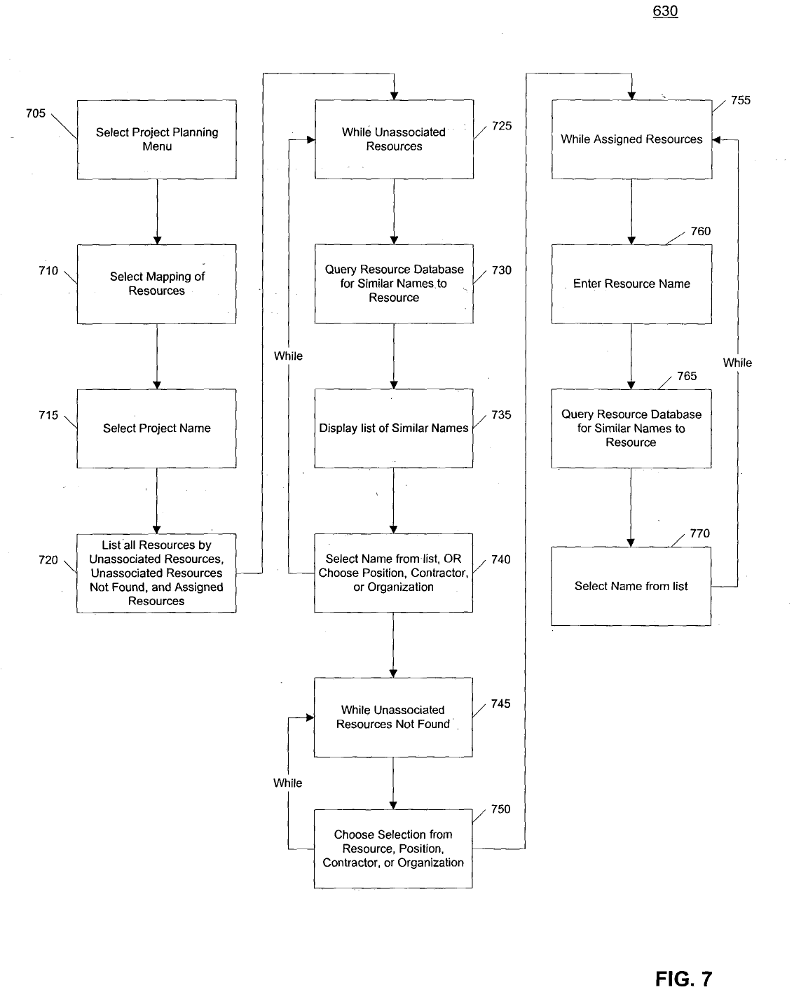

In the above mapping explanation, the mapping function takes place either by PTRS Host 120 based on assigned resources or by project user interaction with PTRS Host 120. This should be distinguished from an assignment operation where a project user, either at PTRS Host 120 or on workstation 110 assigns at least one resources to at least one tasks. Mapping is the function of taking the assigned or unassigned resources and linking them to resource records within Resource Database 150. Mapping resources will be explained more fully with reference to FIG. 7.

After mapped project file 540 is stored in project database 140, mapped project file 540 may be stored as a downloaded mapped project file 530 in the workstation of the project user. This permits local access to downloaded mapped project files 530 by project user 110. As project user 110 modifies mapped project file 540, project user 110 may reinitiate the above described sequence by initiating an upload of the modified mapped project file 540 as was performed with New project file 510. If this occurs, mapping information is uploaded along with the file.

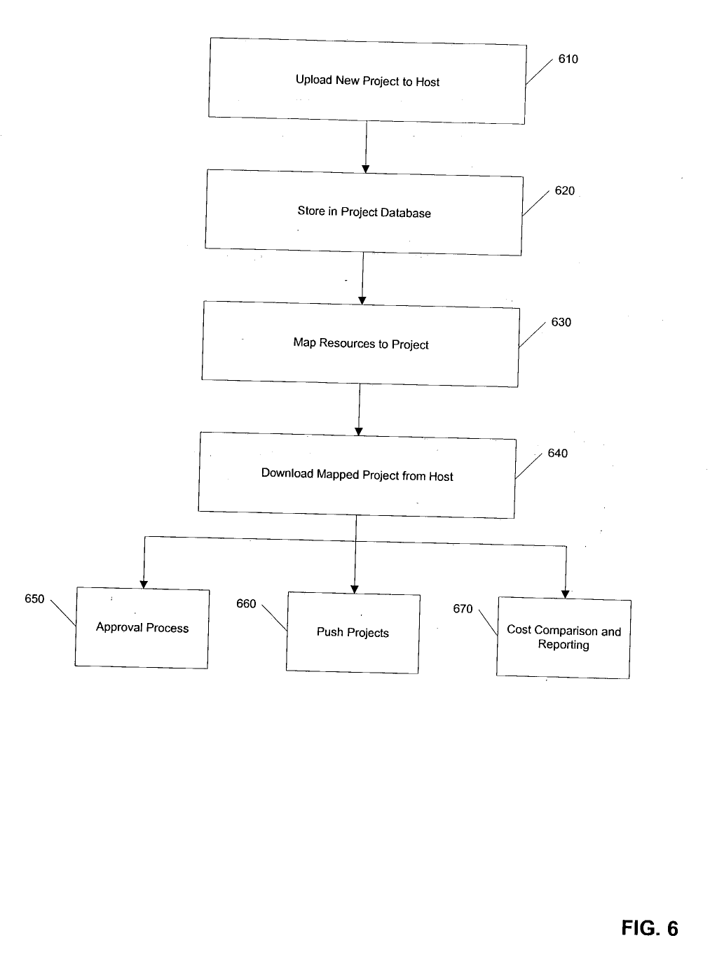

FIG. 6 is a flowchart of a project tracking and analysis method consistent with the present invention. None of the stages outlined below need take place in the particular order described. At stage 610, a new or modified project is uploaded from a workstation to the PTRS host. At stage 620, if the project is a new project it is stored in the project database. If the project is a modification of an existing project, the existing project is replaced with the newly uploaded project.

At stage 630, resources may be mapped to the project. As previously explained, mapping takes the resource records from the resource database and links them to at least one assigned or unassigned resources associated with a task within the project. As will be more fully explained with respect to FIG. 7, assignment by the project user may take place within the PTRS host or by a combination of uploading assignment information with the project file from the workstation and assignment operations on the PTRS host. Following mapping, the mapped project file is saved in the project database.

At stage 640, the project user may download the mapped project file from the PTRS host and project database to the workstation. At stage 650, the project user may designate that a project file is ready for approval by a project manager. At this time, the project manager may be notified that a project file is ready for approval, and the project manager may approve the file, reject the file, or choose not to act. At stage 660, the project may be pushed to the PCTS for cost tracking. Pushing a project to PCTS places all current task assignments for a project file in the PCTS system and cleans up old task assignments.

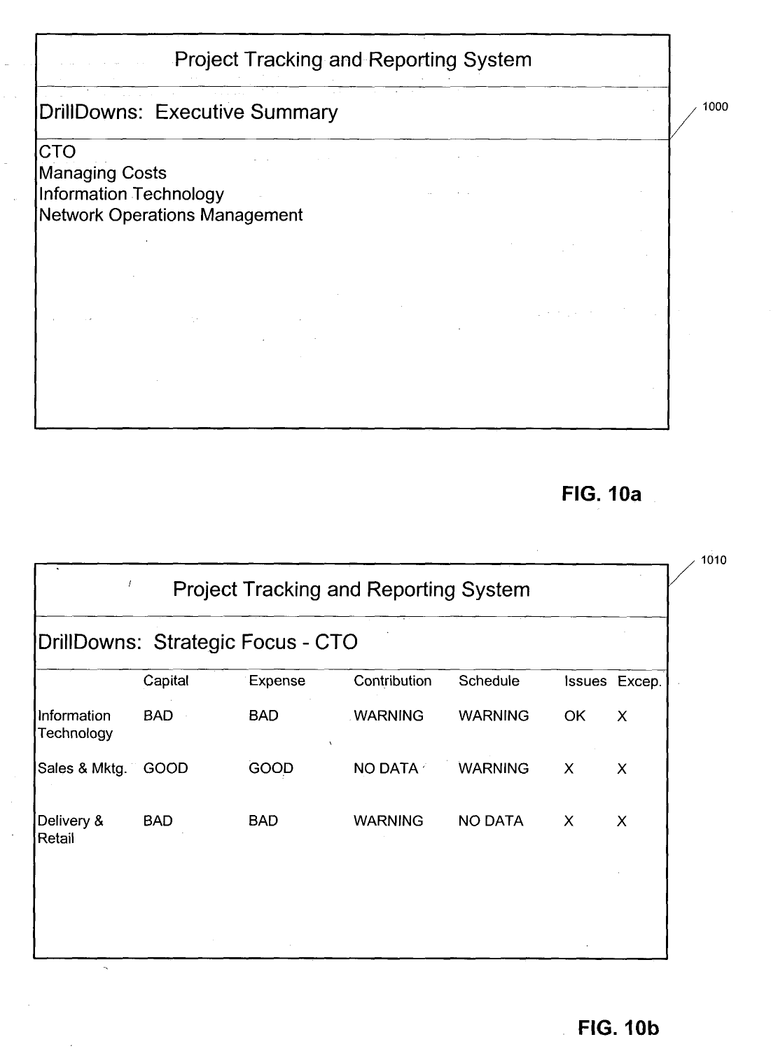

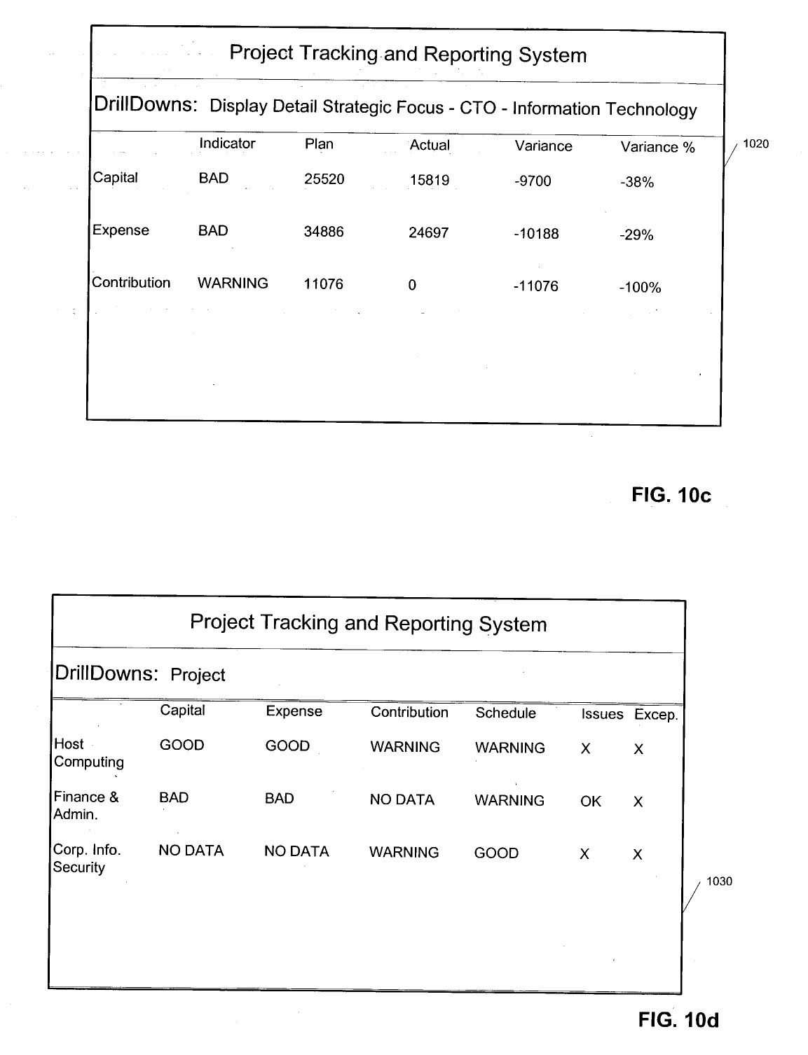

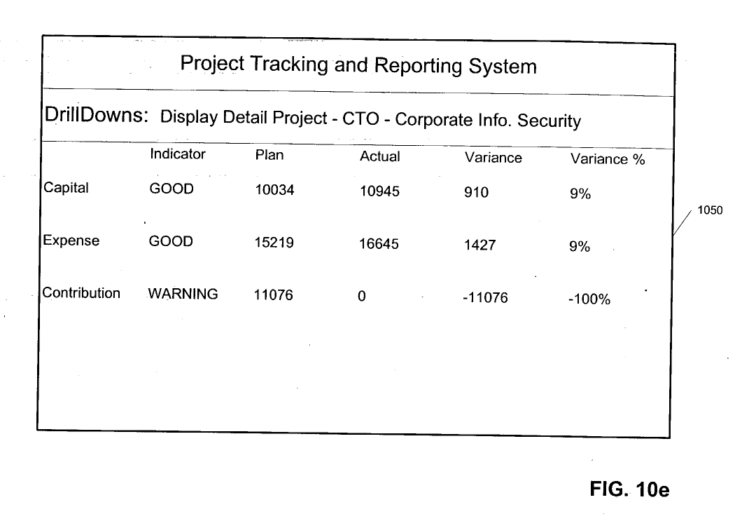

At stage 670, a cost comparison and reporting function may be performed. Cost comparison and reporting will import cost and other actual tracking data from the PCTS and compare it to the actual data to generate reports. Further details of the analysis and reporting process is provided with reference to FIG. 10.

FIG. 7 is a more detailed flowchart of the mapping method consistent with the present invention. Resources may initially be assigned by the project user on the project file saved at the workstation prior to uploading, or the project user may utilize the PTRS Host to assign resources to tasks. Initially, the project user accesses the PTRS Host. Consistent with the present invention, the project user may utilize a web browser to access HTML web screens to facilitate, in a client-server fashion, access to the features of the PTRS Host. At stage 705, the project user may access the project planning menu of the host. At stage 710, the project user may select the Mapping of Resources menu. At stage 715, the host may present the project user with a selection of project files identified by project name from which the project user selects.

At stage 720, once the project file is selected, the process retrieves the project file from the project database and presents the project user with a listing of resources used in the project file. The listing may be grouped by categories, for example unassociated resources, associated resources not found, or assigned resources. Unassociated resources are resources that have been assigned to tasks for which similar resource records exist in the resource database. For example, if the resource “Smith” has been assigned to a task and a query of resource “Smith” in the resource database results in similar records “Bob Smith,” “Frank Smith,” and “Peter Smith,” then the resource “Smith” is an unassociated resource.

Unassociated resources not found are resources that have been assigned to tasks for which similar resource records do not exist in the resource database. For example, if the resource “Gabriella” has been assigned to a task and a query of resource “Gabriella” in the resource database does not result in similar records, then “Gabriella” is an unassociated resource not found.

Associated resources are resources that have already been mapped to resource records in the resource database.

Stages 725-740, 745-750, and 755-770 describe the mapping of unassociated resources, unassociated resources not found, and assigned resources, respectively. At stage 725, a “while” loop is entered. So long as there are unassociated resources, stages 730-740 may be executed. At stage 730, for the first unassociated resource, the resource database is queried for resource records similar to the unassociated resource. At stage 735, the project user is presented with a list of the names in resource records similar to the unassociated resource. At stage 740, the project user may select a name from the provided list or may select an occupational position, (e.g., Level II Program Analyst); a Contractor designation; or an Organization designation, (e.g., Planning and Support Department). The selected resource record is then mapped to the task. Processing may continue back to stage 725 until the unassociated resources are all mapped or the project user chooses to continue to the next stage.

At stage 745, a “while” loop is entered. So long as there are unassociated resources not found, stage 750 will be executed. At stage 750, the project user may select a specific resource from a resource record to be mapped to the task, for example “Bob Smith,” or may select an occupational position, (e.g., Level II Program Analyst); a Contractor designation; or an Organization designation, (e.g., Planning and Support Department). The selected resource record is then mapped to the task. Processing may continue back to stage 745 until the unassociated resources are all mapped or the project user chooses to continue to the next stage.

At stage 755, a “while” loop is entered. So long as there are assigned resources, stages 760-770 may be executed. In this process, the user may add, change, or delete resource records mapped to tasks. At stage 760, for a task the project user may enter a resource name. At stage 765, the process may query the resource database for resource records corresponding to the entered resource name. At stage 770, the project user is presented with a list of similar resource records and may select a resource record to map to the task, for example “Bob Smith,” or may select an occupational position, (e.g., Level II Program Analyst); a Contractor designation; or an Organization designation, (e.g., Planning and Support Department). The selected resource record is then mapped to the task.

Processing may continue back to stage 755 until the assigned resources are all mapped or the project user chooses to end the mapping process.

Those skilled in the art will appreciate that the mapping process need not take place in this particular order and that other variations would be consistent with the present invention.

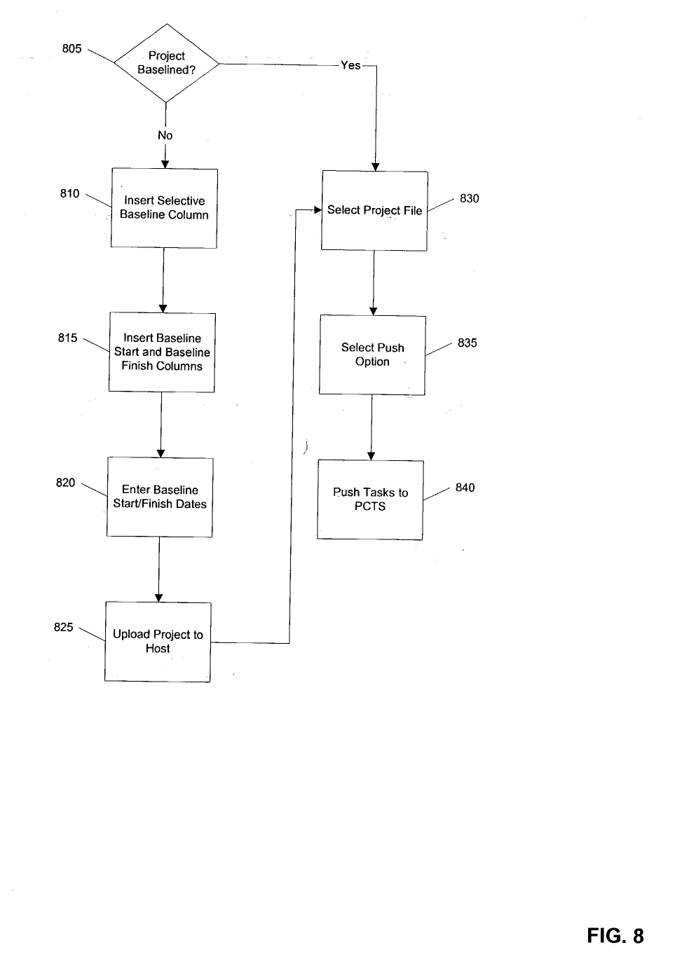

FIG. 8 is a more detailed flowchart of the project push method of consistent with the present invention. Project push method 660 pushes tasks from a project file to the PCTS, so that the process can track costs and other actual values associated with the project file. At stage 805, a check is made to see whether the project file has been “baselined”. Baselining a project file may involve, for at least one tasks within the project file, selecting starting and ending dates for the task. If baselining has not been performed on at least one tasks within the project file, at stage 810, the project user may insert a column into the project file that may be labeled, for example “Selective Baseline?.” At stage 815, the project user may insert two columns labeled, for example “Baseline Start” and “Baseline Finish.” At stage 820, for at least one tasks the project user may enter a baseline start date, a baseline finish date, and select baselining in the “Selective Baseline?” Column. At stage 825, the project user uploads the revised project file to the PTRS Host and project file database, perhaps replacing an existing project file.

At stage 830, the project user selects a project file from the project database. At stage 835, the project user selects the option of pushing the project file to the PCTS. At stage 840, the process pushes the baselined tasks to the PCTS, so that cost and actual data tracking may occur in the PCTS.

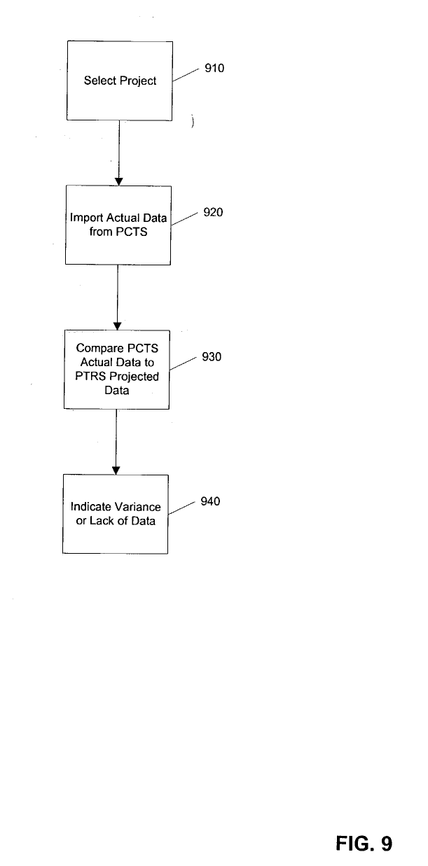

FIG. 9 is a more detailed flowchart of the cost comparison and reporting method consistent with the present invention. Cost comparison compares the actual costs versus the projected costs or other actual data compared to projected data. The projected data may be drawn from the project file in the project database; the actual data may be drawn from a cost or actual data tracking system, such as PCTS. At stage 910, the project user or project manager selects a project file from the project database. At stage 920, the process imports actual data from the PCTS to compare to projected data from the project file drawn from the project database. At stage 930, the process compares the actual data to the projected data.

At stage 940, the process generates indicia of variance or lack of data. The indicia may include various indicators, for example: NO DATA to indicate no data exists to perform a comparison; BAD to indicate that the variance between actual data and projected data is greater than a first percentage, for example 20%; GOOD to indicate that the variance is less than a second percentage, for example 10%; or WARNING to indicate that the variance is greater than the second percentage and less than a third percentage, for example 30%.

The system may also provide indicators of qualitative items. The system may also provide mechanisms for users to track any issues, action items, metrics and period performance associated with a project. Issues are defined as any problems that are encountered during the life of a task or project. Action items are defined as any type of activity assigned to a team member that requires a resolution or follow up. Metrics are defined as project achievements that can be tracked quantitatively or qualitatively. Period performance summarizes what a project has done during the last reporting period (for example, the past month). These tracking mechanisms may be entered and maintained by the user using the web interface. If such data is in the system, a first indicator is given, such as a check mark or “OK”. If such data is not in the system, a second indicator is given, such as an “X”.

Consistent with the present invention, a reporting system may be provided that allows users, project users and project managers, to “drill down” into at least one project files to analyze and track project progress. FIGS. 10a-10f are screen images of the reporting screens consistent with the present invention. FIG. 10a illustrates a screen image 1000 of the first reporting screen viewed at the Executive Summary level. Four Divisions are shown in this exemplary screen: CTO; Managing Costs; Information Technology; and Network Operations Management. Selecting one of the divisions brings forth Strategic Focus screen 1010 illustrated in FIG. 10b.

Strategic Focus Screen 10b illustrates a drill down to the Strategic Focus level for the CTO Division. Illustrated in Strategic Focus Screen 1010 are the relevant subdivisions of the exemplary CTO Division: the Information Technology subdivision; the Sales and Marketing subdivision; and the Delivery and Retail Subdivision. For each subdivision, the indicia of variance or lack of data may be displayed for aspects of projects within the subdivisions. This may be generated by the cost comparison and reporting process as described with respect to FIG. 9.

For example, for the Information Technology subdivisions projects the comparison of actual capital costs to projected capital costs yields a BAD indicator, indicating that actual capital costs exceed projected capital costs by greater than a first percentage, for example 20%. For the scheduling aspect of Information Technology subdivision projects, actual scheduling is delayed from projected scheduling by greater than a first percentage, for example 10%, and less than a second percentage, for example 20%, yielding a WARNING indicator.

Any issues or exceptions flagged or input by users are also indicated on this screen. Selecting an issue or exception may bring forth a window listing the issue or exception.

The user may choose to drill down further into this information to see the figures relating to the comparison for a given area. For example, the user may select Information Technology on screen 1010 which would drill down and bring forth Detail Strategic Focus screen 1020 (FIG. 10c). Screen 1020 repeats the indicia for the Information Technology subdivision of the CTO division bringing up additional details about the actual and projected figures. For example, the Capital area of all projects in the Information Technology subdivision shows a plan figure of 25,520, an actual figure of 15,819, yielding a variance of −9,700 or −38%. This shows the figures behind the BAD indicator.

Individual projects within the Information Technology subdivision may also be broken out and displayed through a drill down. Project drilldown screen 1030, shown in FIG. 10d, illustrates a list of programs and their respective indicia of variance for project categories, for example, Capital, Expense, Contribution, and Schedule. This screen operates similar to screen 1010, except at a lower level in the system, a level displaying specific projects. Any number of levels can be drilled down in this fashion. For example, projects can be grouped by programs, then by subdivision, then by division. Projects may be classified at multiple levels or responsibilities and drilling down can occur to any level or to the base project level.

FIG. 10e displays a detailed project screen similar to FIG. 10c showing the actual figures behind the Corporate Information Security Project.

Through these screens and reporting functions, any of which may be printed or exported for further analysis to other programs or systems, projects can be tracked as they progress to completion.

Those skilled in the art will appreciate that all or part of systems and methods consistent with the present invention may be stored on or read from other computer-readable media, such as: secondary storage devices, like hard disks, floppy disks, and CD-ROM; a carrier wave received from the Internet; or other forms of computer-readable memory, such as read-only memory (ROM) or random-access memory (RAM).

Furthermore, one skilled in the art will also realize that the processes illustrated in this description may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method of tracking a project file, comprising:
uploading a project file to a host system;
storing the project file in the host system;
mapping at least one resource record from a resources database to a task within the project file to produce a mapped project file; and
storing the mapped project file on the host system.

2. The method of claim 1, further comprising downloading the mapped project file to a client system.

3. The method of claim 1, further comprising baselining at least one task within the mapped project file to produce a baselined mapped project file.

4. The method of claim 3, wherein the baseline mapped project file included projected costs and further comprising pushing the baselined mapped project file to a cost tracking system for tracking costs associated with at least one baselined task of the baselined mapped project file.

5. The method of claim 4, further comprising:
receiving actual costs associated with at least one task of the baselined mapped project file;
comparing the projected costs, associated with the at least one task of the baselined mapped project file, with the actual costs associated with the at least one task of the baselined mapped project file; and
generating a report of the comparison of the projected costs associated with the at least one task with the actual costs associated with the at least one task.

6. The method of claim 5 comprising generating a variance, and wherein generating a report comprises generating a report comprising an indicator of the variance between the projected costs associated with the at least one task and the actual costs associated with the at least one task.

7. The method of claim 5 wherein generating a report comprises generating a report comprising the projected costs associated with the at least one task, the actual costs associated with the at least one task, and a percentage of variance between the projected costs and the actual costs.

8. The method of claim 5, wherein uploading a project file comprises uploading a plurality of project files, and the method further comprises grouping the plurality of project files into a program, and generating a report comprises generating a report including summed data on the actual costs associated with the program and the variable costs associated with the program.

9. The method of claim 1, further comprising assigning a resource to a task within the project file to produce an assigned resource.

10. The method of claim 9, wherein mapping at least one resource record further comprises:
comparing the assigned resource to at least one resource record within the resource database;
providing a listing of at least one resource record similar to the assigned resource; and
selecting from the listing at least one resource record to map to the task.

11. The method of claim 10, wherein the assigned resource has no similar resource record in the resource database, and further comprising:
providing a listing of at least one non-similar resource record;
selecting at least one of the at least one non-similar resource from the listing; and
mapping the selected, non-similar resource to the task.

12. The method of claim 1, wherein mapping at least one resource record further comprises:
generating a listing of at least one resource record of at least one occupational positions, at least one contractor designations, or at least one organization designations;
selecting at least one of the at least one resource record from the listing; and
mapping the selected resource record to the task.

13. A method of reporting tracking information on project files, comprising:
baselining at least one task of a project file, wherein the project file comprises at least one task with associated projected data;
pushing the at least one baselined tasks to a cost tracking system;
receiving actual data associated with the at least one baselined tasks from the cost tracking system;
comparing the actual data from the costs tracking system with the projected data; and
generating a report of the actual data and the projected data.

14. The method of claim 13, wherein generating the report further comprises generating a report including an indicator of the variance between the actual data and the projected data for a task.

15. The method of claim 14, wherein generating the report comprises generating a report including a good indicator if the variance is less than a first percentage.

16. The method of claim 14, wherein generating the report comprises generating a report including a warning indicator if the variance is greater than a first percentage and less than a second percentage.

17. The method of claim 14, wherein generating the report comprises generating a report including a bad indicator if the variance is greater than a second percentage.

18. The method of claim 13 further comprising assigning at least two projects to a program.

19. The method of claim 18 further comprising:
grouping the actual data for the projects and grouping projected data for the projects; and
generating a report on the grouped actual data and the grouped projected data.

20. A system for tracking a project file, comprising:
a memory;
a database;
a processor coupled to the memory and the database, the processor configured to:
receive a project file;
store the project file in the database;
map at least one resource record from the database to a task within the project file to produce a mapped project file; and
store the mapped project file in the database.

21. The system of claim 20, wherein the processor is further operable to send the project file to a client system.

22. The system of claim 20, wherein the processor is further operable to baseline at least one task within the mapped project file to produce a baselined mapped project file.

23. The system of claim 22, wherein the baselined mapped project file includes projected costs and further wherein the processor is further operable to push the baselined mapped project file to a cost tracking system for tracking costs associated with at least one baselined task of the baselined mapped project file.

24. The system of claim 23, wherein the processor is further operable to:
receive actual costs associated with at least one task of the baselined mapped project file;
compare the projected costs, associated with the at least one task of the baselined mapped project file, with the actual costs associated with the at least one task of the baselined mapped project file; and
generate a report of the comparison of the projected costs associated with the at least one task with the actual costs associated with the at least one task.

25. The system of claim 24, wherein the processor is further operable to:
generate a variance; and
generate a report comprising an indicator of the variance between the projected costs associated with the at least one task and the actual costs associated with the at least one task.

26. The system of claim 24, wherein the processor is further operable to:
generate a report comprising the projected costs associated with the at least one task,-the actual costs associated with the at least one task, and a percentage of variance between the projected costs and the actual costs.

27. The system of claim 24, wherein the processor is further operable to:
receive a plurality of project files;
group the plurality of project files into a program; and
generate a report including summed data on the actual costs associated with the program and the variable costs associated with the program.

28. The system of claim 20, wherein the processor is further operable to assign a resource to a task within the project file to produce an assigned resource.

29. The system of claim 28, wherein the processor is further operable to:
compare the assigned resource to at least one resource record within the database;
provide a listing of at least one resource record similar to the assigned resource; and
select from the listing at least one resource record to map to the task.

30. The system of claim 29, wherein the assigned resource has no similar resource record in the resource database, and the processor is further operable to:
provide a listing of at least one non-similar resource record;
select at least one of the at least one non-similar resource from the listing; and
map the selected, non-similar resource to the task.

31. The system of claim 20, wherein the processor is further operable to:
generate a listing of at least one resource record of at least one occupational positions, at least one contractor designations, or at least one organization designations;
select at least one of the at least one resource record from the listing; and
map the selected resource record to the task.

32. A system for reporting tracking information on project files, comprising:
a memory;
a database;
a processor coupled to the memory and the database, the processor configured to:
baseline at least one task of a project file, wherein the project file comprises at least one task with associated projected data;
push the at least one baselined task to a cost tracking system;
receive actual data associated with the at least one baselined tasks from the cost tracking system;
compare the actual data from the costs tracking system with the projected data; and
generate a report of the actual data and the projected data.

33. The system of claim 32, wherein the processor is further operable to generate a report including an indicator of the variance between the actual data and the projected data for a task.

34. The system of claim 33, wherein the processor is further operable to generate a report including a good indicator if the variance is less than a first percentage.

35. The system of claim 33, wherein the processor is further operable to generate a report including a warning indicator if the variance is greater than a first percentage and less than a second percentage.

36. The system of claim 33, wherein the processor is further operable to generate a report including a bad indicator if the variance is greater than a second percentage.

37. The system of claim 32 wherein the processor is further operable to assign at least two projects to a program.

38. The system of claim 37 wherein the processor is further operable to:
group the actual data for the projects and grouping projected data for the projects; and
generate a report on the grouped actual data and the grouped projected data.

39. A computer-readable medium on which is stored a set of instructions for tracking-a-project file, which when executed perform stages comprising:
uploading a project file to a host system;
storing the project file in the host system;
mapping at least one resource record from a resources database to a task within the project file to produce a mapped project file; and
storing the mapped project file on the host system.

40. The computer-readable medium of claim 39, further comprising instructions for downloading the mapped project file to a client system.

41. The computer-readable medium of claim 39, further comprising instructions for baselining at least one task within the mapped project file to produce a baselined mapped project file.

42. The computer-readable medium of claim 41, wherein the baseline mapped project file included projected costs and further comprising instructions for pushing the baselined mapped project file to a cost tracking system for tracking costs associated with at least one baselined task of the baselined mapped project file.

43. The computer-readable medium of claim 42, further comprising instructions for:
receiving actual costs associated with at least one task of the baselined mapped project file;
comparing the projected costs, associated with the at least one task of the baselined mapped project file, with the actual costs associated with the at least one task of the baselined mapped project file; and
generating a report of the comparison of the projected costs associated with the at least one task with the actual costs associated with the at least one task.

44. The computer-readable medium of claim 43 further comprising instructions for generating a variance, and wherein generating a report comprises generating a report comprising an indicator of the variance between the projected costs associated with the at least one task and the actual costs associated with the at least one task.

45. The computer-readable medium of claim 43 wherein generating a report comprises generating a report comprising the projected costs associated with the at least one task, the actual costs associated with the at least one task, and a percentage of variance between the projected costs and the actual costs.

46. The computer-readable medium of claim 43, wherein uploading a project file comprises uploading a plurality of project files, and the method further comprises grouping the plurality of project files into a program, and generating a report comprises generating a report including summed data on the actual costs associated with the program and the variable costs associated with the program.

47. The computer-readable medium of claim 39, further comprising instructions for assigning a resource to a task within the project file to produce an assigned resource.

48. The computer-readable medium of claim 47, wherein mapping at least one resource record further comprises:
comparing the assigned resource to at least one resource record within the resource database;
providing a listing of at least one resource record similar to the assigned resource; and
selecting from the listing at least one resource record to map to the task.

49. The computer-readable medium of claim 48, wherein the assigned resource has no similar resource record in the resource database, and further comprising instructions for:
providing listing at least one resource record;
selecting at least one of the at least one non-similar resource from the listing; and
mapping the selected, non-similar resource to the task.

50. The computer-readable medium of claim 39, wherein mapping at least one resource record further comprises:
generating a listing of at least one resource record of at least one occupational positions, at least one contractor designations, or at least one organization designations;
selecting at least one of the at least one resource record from the listing; and
mapping the selected resource record to the task.

51. A computer-readable medium on which is stored a set of instructions for reporting tracking information on project files, which when executed perform stages comprising:
baselining at least one task of a project file, wherein the project file comprises at least one task with associated projected data;
pushing the at least one baselined tasks to a cost tracking system;
receiving actual data associated with the at least one baselined tasks from the cost tracking system;
comparing the actual data from the costs tracking system with the projected data; and
generating a report of the actual data and the projected data.

52. The computer-readable medium of claim 51, wherein generating the report further comprises generating a report including an indicator of the variance between the actual data and the projected data for a task.

53. The computer-readable medium of claim 52, wherein generating the report comprises generating a report including a good indicator if the variance is less than a first percentage.

54. The computer-readable medium of claim 52, wherein generating the report comprises generating a report including a warning indicator if the variance is greater than a first percentage and less than a second percentage.

55. The computer-readable medium of claim 52, wherein generating the report comprises generating a report including a bad indicator if the variance is greater than a second percentage.

56. The computer-readable medium of claim 51 further comprising instructions for assigning at least two projects to a program.

57. The computer-readable medium of claim 56 further comprising instructions for:
grouping the actual data for the projects and grouping projected data for the projects; and
generating a report on the grouped actual data and the grouped projected data.
